(19) United States
(12) Patent Application Publication
(10) Pub. No.: US 2023/0247500 A1
(43) Pub. Date: Aug. 3, 2023

(54) LATENCY CONTROL FOR A COMMUNICATION NETWORK

(71) Applicant: Telefonaktiebolaget LM Ericsson (publ), Stockholm (SE)

(72) Inventors: Christer ÖSTBERG, STAFFANSTORP (SE); Emma WITTENMARK, LUND (SE); Henrik RONKAINEN, SÖDRA SANDBY (SE); Johan STRAND, STAFFANSTORP (SE); Kjell GUSTAFSSON, LUND (SE); Torbjörn SÖLVE, MALMÖ (SE)

(21) Appl. No.: 18/011,984

(22) PCT Filed: Jul. 1, 2020
(86) PCT No.: PCT/EP2020/068581

§ 371 Date: Dec. 21, 2022

(51) Int. Cl. H04W 36/00

(52) U.S. Cl. CPC H04W 36/0094; H04W 36/00837

(57) ABSTRACT

A method for latency control in a communication network is disclosed. The method includes identifying that a service is currently associated with a user device associated with the communication network, wherein a deviation between a latency requirement of the service and an internal latency performance of the communication network is bounded, and dynamically adjusting one or more handover criteria for the user device associated with the service. In some embodiments, the dynamic adjustment is performed only for user devices associated with services with bounded deviation between the latency requirement of the service and the internal latency performance of the communication network.

### TECHNICAL FIELD

The present disclosure relates generally to the field of wireless communication. More particularly, it relates to latency control in wireless communication scenarios.

### BACKGROUND

Different forms of latency control are generally applied in wireless communication scenarios. In some situations, existing approaches for latency control do not provide for desirable performance.

Therefore, there is a need for alternative approaches for latency control.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for latency control in a communication network. The method comprises identifying that a service is currently associated with a user device associated with the communication network, wherein a deviation between a latency requirement of the service and an internal latency performance of the communication network is bounded, and dynamically adjusting one or more handover criteria for the user device associated with the service.

In some embodiments, dynamically adjusting the one or more handover criteria is performed only for user devices associated with services with bounded deviation between the latency requirement of the service and the internal latency performance of the communication network.

In some embodiments, dynamically adjusting one or more handover criteria comprises switching from a first handover criterion to a second handover criterion, wherein the first handover criterion corresponds to a first handover probability and the second handover criterion corresponds to a second handover probability which is lower than the first handover probability.

In some embodiments, dynamically adjusting one or more handover criteria comprises associating the user device with a handover inertia and/or reducing a probability of handover.

In some embodiments, dynamically adjusting one or more handover criteria comprises one or more of: adjusting a handover measurement configuration of the user device, and adjusting a handover decision criterion for the user device.

In some embodiments, the dynamically adjusting one or more handover criteria comprises adjusting one or more handover related values.

In some embodiments, dynamically adjusting one or more handover criteria comprises one or more of: decreasing a signal quality threshold value for serving cell, and increasing a signal quality threshold value for target cell.

In some embodiments, dynamically adjusting one or more handover criteria comprises adjusting a signal quality difference threshold value for signal quality differences between serving cell and target cell.

In some embodiments, dynamically adjusting one or more handover criteria comprises excluding, in a load balancing procedure, the user device from consideration for handover.

In some embodiments, identifying that a service is currently associated with a user device, wherein the deviation between the latency requirement of the service and the internal latency performance of the communication network is bounded, comprises one or more of: detecting that a service class identifier is indicative of the service, detecting that a bearer dedicated for low latency requirements is assigned for the service, and determining that a traffic pattern of the service matches a latency sensitive traffic pattern.

In some embodiments, the bounded deviation between the latency requirement of the service and the internal latency performance of the communication network comprises one or more of: a ratio between a latency requirement parameter value of the service and an internal latency performance parameter value of the communication network falling within a bounding range, a latency requirement parameter value of the service and an internal latency performance parameter value of the communication network being in a same order of magnitude, a latency requirement parameter value of the service and an internal latency performance parameter value of the communication network being equal, and a required end-to-end round-trip-time of the service falling within a time range specified relative an internal round-trip-time of the communication network.

In some embodiments, the service has a maximum allowable latency which is lower than that of mobile broadband (MBB) services and/or higher than that of ultra-reliable low latency communication (URLLC) services.

In some embodiments, the latency control comprises one or more of: decrease of latency variance associated with the communication network for the user device, decrease of a maximum latency associated with the communication network for the user device, decrease of a number of latency events associated with the communication network for the user device, that exceed a latency threshold value, and decrease of an average latency associated with the communication network for the user device.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for latency control in a communication network. The apparatus comprises controlling circuitry configured to cause identification that a service is currently associated with a user device associated with the communication network, wherein a deviation between a latency requirement of the service and an internal latency performance of the communication network is bounded, and dynamic adjustment of one or more handover criteria for the user device associated with the service.

A fourth aspect is a network node comprising the apparatus of the third aspect.

In some embodiments, any of the above aspects may additionally have features identical with or corresponding to any of the various features as explained above for any of the other aspects.

An advantage of some embodiments is that alternative approaches for latency control are provided. Generally, the alternative approaches for latency control may be used instead of, or together with, other approaches for latency control, as suitable.

An advantage of some embodiments is that the number of handovers is reduced.

An advantage of some embodiments is that the probability of occurrences with relatively large latency (e.g., latency spikes) may be reduced.

An advantage of some embodiments is that the average latency may be reduced.

An advantage of some embodiments is that the latency variance may be reduced.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic block diagram illustrates an example communication scenario according to some embodiments;

FIG. 2 is a schematic block diagram illustrates an example communication scenario according to some embodiments;

FIG. 3 is a flowchart illustrating example method steps according to some embodiments;

FIG. 4 is a schematic drawing illustrating example principles according to some embodiments;

FIG. 5 is a plot diagram illustrating example principles according to some embodiments;

FIG. 6 is a schematic block diagram illustrating an example apparatus according to some embodiments; and

FIG. 7 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

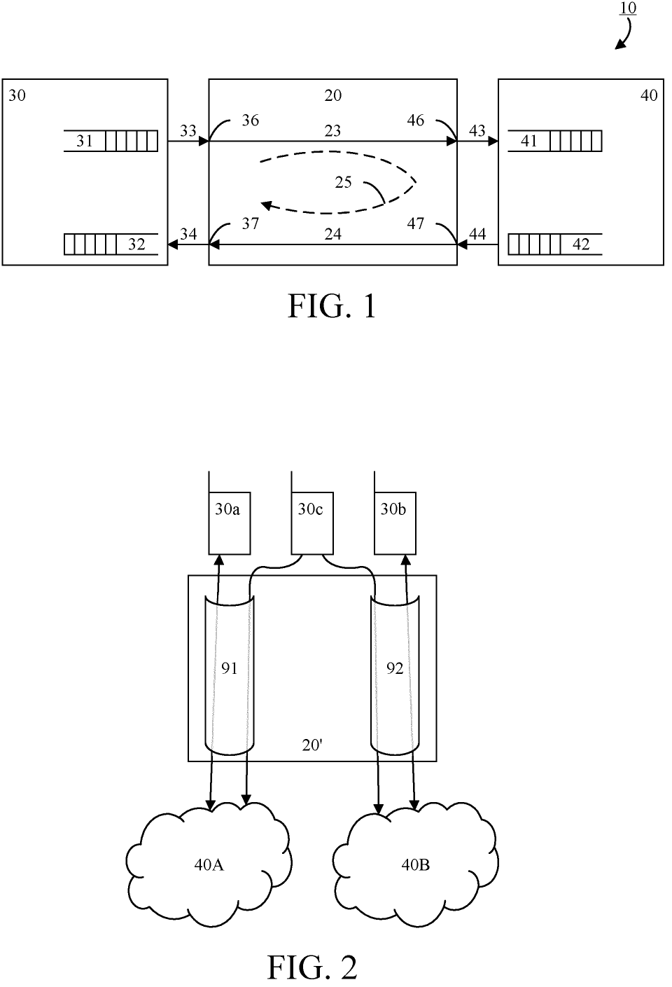

As mentioned before, different forms of latency control are generally applied in wireless communication scenarios. FIG. 1 schematically illustrates a communication scenario 10 for demonstrating a type of situation where latency control may be challenging.

The communication scenario 10 comprises two communication end points 30, 40 and a communication network 20. The communication network 20 is for carrying information (e.g., data and/or control information) from end point 30 to end point 40 as illustrated by 33, 23, and 43 and/or from end point 40 to end point 30 as illustrated by 44, 24, and 34.

The end points 30, 40 may be any suitable communication end points. One example of a communication end point pair is an application client-server pair.

Depending on the type of service the end points 30, 40 are engaged in, there may be different latency requirements on the communication between the end points 30, 40.

Generally, latency of communication between the end points 30, 40 may be defined as one or more of: a time for transfer of information from end point 30 to end point 40 (possibly defined as a time between information entering a transmission buffer 31 associated with the end point 30 and the same information being dispatched from a reception buffer 41 associated with the end point 40), a time for transfer of information from end point 40 to end point 30 (possibly defined as a time between information entering a transmission buffer 42 associated with the end point 40 and the same information being dispatched from a reception buffer 32 associated with the end point 30), a time from issuing of first information at end point 30 (possibly defined as a time when the first information enters a transmission buffer 31 associated with the end point 30) to reception of second information at end point 30 (possibly defined as a time when the second information is dispatched from a reception buffer 32 associated with the end point 30) wherein the second information is issued by end point 40 in response to reception of the first information, and a time from issuing of first information at end point 40 (possibly defined as a time when the first information enters a transmission buffer 42 associated with the end point 40) to reception of second information at end point 40 (possibly defined as a time when the second information is dispatched from a reception buffer 41 associated with the end point 40) wherein the second information is issued by end point 30 in response to reception of the first information.

Alternatively or additionally, and generally, latency of communication between end points may be characterized by one or more of: an average duration of end point to end point transfer, a minimum duration of end point to end point transfer, a maximum duration of end point to end point transfer, a variance of the duration of end point to end point transfer, and a probability that duration of end point to end point transfer exceeds a duration threshold.

Generally, end point to end point transfer may refer to a one way transfer or to a round-trip-time (RTT).

The latency requirements on the communication between the end points may be defined according to any of the above, or other suitable, definitions and characterization. For example, a specific service may require that the time from issuing of first information at end point 30 to reception of second information at end point 30 (wherein the second information is issued by end point 40 in response to reception of the first information) is below a maximum duration value and/or has a variance below a maximum variance value.

The communication network 20 may be any suitable communication network. One example of a communication network is any wireless communication network operating in accordance with a standard advocated by the third generation partnership project (3GPP); e.g., the universal mobile telecommunication system (UMTS), UMTS long term evolution (LTE), or a fifth generation (5G) system. The communication network may, for example, comprise a radio access network (RAN) and/or a core network (CN).

The communication network 20 typically has an internal latency performance, schematically illustrated by 25.

The internal latency performance 25 of the communication network 20 determines (e.g., limits) how quickly information delivered to the communication network at 36 can be transferred through the communication network over 23 and provided at 46 and/or how quickly information delivered to the communication network at 47 can be transferred through the communication network over 24 and provided at 37.

The internal latency performance 25 of the communication network 20 may be characterized in terms of the duration (delay) of the transfer over 23 and/or 24. For example, the internal latency performance 25 of the communication network 20 may be characterized by one or more of: an average duration of transfer through the communication network, a minimum duration of transfer through the communication network, a maximum duration of transfer through the communication network, a variance of the duration of transfer through the communication network, and a probability that duration of transfer through the communication network exceeds a duration threshold.

Generally, transfer through the communication network may refer to a one way transfer or to a round-trip-time (RTT).

The internal latency performance 25 of the communication network 20 may be caused by one or more of various (standardized or non-standardized) settings and limitations of the communication network. Some example settings and limitations of a communication network that inherently introduce latency include – but are not limited to – standardized time domain dimensions of communication resources (e.g., time duration of one or more units for communication), scheduling principles, protocols (e.g., retransmission protocols such as hybrid automatic repeat request – HARQ), and response requirements (e.g., for acknowledgement –ACK).

When the latency requirements on the communication between the end points are easily accommodated by the internal latency performance of the communication network, the end-to-end communication scenario is unproblematic from a latency perspective.

Such situations may, for example, occur when an average duration of transfer through the communication network is much lower than a required average duration of end point to end point transfer, when a maximum duration of transfer through the communication network is much lower than a required maximum (or average) duration of end point to end point transfer, and/or when a variance of duration of transfer through the communication network is much lower than a required maximum variance of duration of end point to end point transfer.

When the latency requirements on the communication between the end points are impossible to fully accommodate by the internal latency performance of the communication network, the end-to-end communication scenario is infeasible from a latency perspective.

Such situations may, for example, occur when an average duration of transfer through the communication network is much higher than a required average duration of end point to end point transfer, when a minimum duration of transfer through the communication network is higher than a required minimum (or average) duration of end point to end point transfer, and/or when a variance of duration of transfer through the communication network is higher than a required maximum variance of duration of end point to end point transfer.

These problems may be solved by application of a different communication network, or a specifically designed communication type within the communication network, to accommodate the latency requirements on the communication between the end points.

Embodiments presented herein are particularly applicable in situations which are neither of the above, i.e., situations when the latency requirements on the communication between the end points are not impossible, but not easy either, to accommodate by the internal latency performance of the communication network. Then, the end-to-end communication scenario is feasible, but problematic (e.g., presenting challenges), from a latency perspective. This may be seen as the end-to-end communication scenario comprising a service which is latency sensitive (i.e., with latency requirements on the communication between the end points) in relation to the internal latency performance of the communication network (i.e., latency sensitive service).

Such situations may, for example, occur when an average duration of transfer through the communication network is similar to a required average duration of end point to end point transfer, when a maximum duration of transfer through the communication network is similar to a required maximum duration of end point to end point transfer, and/or when a variance of duration of transfer through the communication network is similar to a required maximum variance of duration of end point to end point transfer.

Generally, a latency sensitive service associated with a user of a communication network may be defined as a service with latency requirements on the communication between the end points which are similar to the internal latency performance of the communication network.

For example, a latency sensitive service associated with a user of a communication network may be defined as a service with one or more latency requirement parameter value (e.g., average duration of transfer, maximum duration of transfer, variance of transfer duration, etc.) for the communication between the end points being in the same order of magnitude as the value of a corresponding parameter of the internal latency performance of the communication network.

Alternatively or additionally, a latency sensitive service associated with a user of a communication network may be defined as a service with one or more latency requirement parameter value (e.g., average duration of transfer, maximum duration of transfer, variance of transfer duration, etc.) for the communication between the end points deviating from the value of a corresponding, or otherwise relevant, parameter of the internal latency performance of the communication network by less than a threshold value.

Alternatively or additionally, a latency sensitive service associated with a user of a communication network may be defined as a service with a requirement of maximum duration of transfer for the communication between the end points which is lower than a maximum duration of transfer through the communication network.

Alternatively or additionally, a latency sensitive service associated with a user of a communication network may be defined as a service with a requirement of average duration of transfer for the communication between the end points deviates from an average duration of transfer through the communication network by less than a threshold value.

Alternatively or additionally, a latency sensitive service associated with a user of a communication network may be defined as a service with a requirement of variance of duration of transfer for the communication between the end points which is lower than a value based on a variance of duration of transfer through the communication network (e.g., lower than the variance of duration of transfer through the communication network, or lower than the variance of duration of transfer through the communication network plus or minus a bias value).

The problems associated with latency sensitive services may be solved in the same way as situations where the end-to-end communication scenario is infeasible from a latency perspective, i.e., by application of a different communication network, or a specifically designed communication type within the communication network, to more easily accommodate the latency requirements on the communication between the end points. However, application of a communication network (or a specifically designed communication type within a communication network) which accommodates strict latency requirements on the communication between the end points is typically inefficient in terms of throughput and/or capacity. For example, increasing the amount of allocated communication resources is one approach that is helpful to accommodate strict latency requirements on the communication between the end points, but has a negative impact on overall throughput of the communication network.

Therefore, there is a need for alternative approaches for latency control, which preferably address the problems associated with latency sensitive services (i.e., services with a sensitive relationship between latency requirements on the communication between the end points and the internal latency performance of the communication network).

A more detailed context will now be described, in relation to which embodiments may be particularly applicable. It should be noted that the following context is merely an illustrative example and not to be construed as limiting.

Some typical existing wireless communication networks (e.g., 3GPP-based networks supporting fourth generation, 4G, and earlier releases of the communication standard) are mainly optimized for mobile broadband (MBB) services and voice services. Generally, MBB traffic is not particularly latency sensitive but can be very throughput demanding. For example, for streaming services latency is typically handled by using large buffers which will efficiently hide latency jitter caused by latency events in the communication network, and thereby provide good end user experience. This exemplifies situations when the latency requirements on the communication between the end points are easily accommodated by the internal latency performance of the communication network, and the end-to-end communication scenario is unproblematic from a latency perspective.

In later releases of 4G, and especially in 5G, services of other types than MBB and voice have come into focus. One example is ultra-reliable low latency communication (URLLC) services. URLLC may be particularly suitable for industrial applications. Within 3GPP standardization, features are developed to support these new URLLC services and use cases. This exemplifies situations when the latency requirements on the communication between the end points are impossible to fully accommodate by the internal latency performance of the communication network, the end-to-end communication scenario is infeasible from a latency perspective, and a specifically designed communication type within the communication network is applied to accommodate the latency requirements on the communication between the end points.

Embodiments presented herein are particularly applicable in situations which are neither of the above (MBB, voice, and URLLC), i.e., situations when the latency requirements on the communication between the end points are not impossible, but not easy either, to accommodate by the internal latency performance of the communication network (referred to herein as latency sensitive services). In some embodiments, a relatively high throughput is also required (which is typically not the case for services requiring a specifically designed communication type, e.g., URLLC).

Some typical example services where embodiments may be particularly applicable – e.g., in the context of a 3GPP-based communication network – are gaming applications (gaming with or without rendering, and including multi-user gaming), augmented reality (AR), virtual reality (VR), and tele-operated vehicle control (e.g., driving).

Generally, the latency through the radio network (RAN), the core network (CN), and all the way to the communication end points (e.g., application client and application server) needs to be considered in view of latency requirements on the communication between the end points. One approach to reduce the impact of CN latency and/or of latency between the communication network and the application server, is to apply an edge cloud deployment of the application.

For situations when the latency requirements on the communication between the end points are not impossible, but not easy either, to accommodate by the internal latency performance of the communication network, some example latency requirements include a maximum round-trip-time (RTT) for communication between end points (end-to-end, E2E, RTT) in any of the ranges 10-100 ms, 30-100 ms, 30-50 ms, and 80-100 ms, and/or some example throughput requirements include a throughput in the range 5-10 Mbps or there over; up to 400 Mbps (e.g., for VR streaming applications).

For situations when the latency requirements on the communication between the end points are not impossible, but not easy either, to accommodate by the internal latency performance of the communication network, it may be further beneficial to consider reliability of the communication (e.g., measured as the probability of delivering traffic within a specified time duration, i.e., fulfilling the latency requirement). The reliability is tightly coupled with the latency requirements (without any latency requirement, the traffic can always be delivered, e.g., by using sufficiently many retransmissions). Thus, reliability is a relevant metric when a communication network is tuned for latency sensitive traffic.

Thus, some communication networks are typically dimensioned and configured to provide services (e.g., for MBB traffic) with high throughput and relatively relaxed latency requirements. Although latency is typically considered in such communication networks (e.g., in relation to transmission control protocol, TCP, throughput and ramp-up times), predictable latency (i.e., low latency variance) is typically not required. One explanation to the latter is that the timing requirements in some human-machine interaction (e.g., web-browsing and video streaming) is quite relaxed and rather large latency variations can be hidden with buffers.

For latency sensitive services, however, extensive use of buffers is not possible due to the nature of the applications (e.g., quick reaction times required for gaming, fast control response required for vehicle tele-operation, etc.). Typically, a latency spike will have negative impact on the application experience/performance for latency sensitive services. Some example events in a communication network that may cause latency spikes include handovers, slow fading dips, and fast fading dips.

In association with some typical communication networks (e.g., 3GPP-based networks for 4G and 5G), efforts are made to reduce overall latency (e.g., reducing the average latency). This, however, does not exclude a relatively large maximum latency and/or a relatively large latency variation (which may result in latency spikes, for example).

Regarding handover, some typical communication networks (e.g., 3GPP-based networks for 4G and 5G) apply a handover mechanism where service by one cell is released before service setup towards a target cell is completed. This mechanism causes a brief communication interruption during the handover procedure. The interruption may, for example, be in the range 30-60 ms, or considerably longer (e.g., up to 100 ms, or up to several hundreds of ms, such as 200 ms, 500 ms, or 900 ms).

For MBB services and voice services, these handover interruptions typically do not negatively affect the quality of the services, since the latency caused by the interrupt can be hidden with buffer management. For latency sensitive services, however, the length of these handover interruptions may be in the same order of magnitude as the latency requirements of the service, and a handover can negatively affect the quality of the service.

Hence, some approaches for latency control may comprise avoiding unnecessary handovers, at least for latency sensitive services, while performing handovers that are necessary to maintain connection between the communication network and a device operating at the communication end point.

Alternatively or additionally, some approaches for latency control may comprise controlling the setting of one or more network configuration parameter, at least for latency sensitive services.

Generally, there are many network configuration parameters that potentially impact the latency of a communication network. Examples include: the scheduling request periodicity (for UE initiated transmissions), the coding and modulation selected for HARQ retransmissions, the maximum number of HARQ retransmissions, timer settings in medium access control (MAC), timer settings in radio link control (RLC).

For MBB services and voice services, the setting of these configuration parameters typically have negligible impact on the user experience, since any un-acceptable latency jitter can be hidden with buffer management. For latency sensitive services, however, the setting of these configuration parameters can have a negative effect on the user experience since they might affect the variation in latency and/or the maximum latency.

Hence, some approaches for latency control may comprise controlling the setting of one or more network configuration parameter, at least for latency sensitive services, to provide latencies which are predictable (i.e., low variation in latency) and relatively low (i.e., low maximum latency).

Generally, some approaches for latency control may comprise keeping latency predictable and relatively low (bounded and predictable), while (preferably) enabling maintenance of the communication connection through the communication network at a predictable throughput. Thereby, latency sensitive services can be satisfactorily supported in the communication network.

Alternatively or additionally, some approaches for latency control may comprise, at least for latency sensitive services, informing the application about current and/or future conditions of the communication network that impact throughput and/or latency.

For example, when the application receives information that the throughput of the communication network throughput is decreasing, or predicted to decrease in a near future, the application can adapt to this situation. Example adaptions by the application include lowering of a data rate (e.g., by lowering an encoder rate, such as a video encoding rate).

Some communication networks already have approaches for differentiating services in RAN, which may be used for differentiation also in relation to latency sensitive services as defined herein. In some embodiments, such approaches may be combined with the alternative approaches for latency control presented herein.

Examples of already existing approaches for differentiating services in RAN include slicing, dedicated bearers, resource assignment differentiation, scheduling prioritization, etc. For example, some legacy solutions allow an operator to assign more or less resources and/or set a priority for a bearer that transport a specific service type (e.g., voice over LTE, VoLTE). Such approaches may comprise assigning different service class identifiers (e.g., quality-of-service class identifier - QCI, 5QI, etc.) to different bearers based on which type of service is carried by the bearer. Alternatively or additionally, some legacy solutions allow an operator to enable different types of services based on which type of subscription is associated with a user device.

FIG. 2 schematically illustrates a communication scenario with differentiated bearers. The user device 30a communicates with an application dwelling in the Internet 40A via the communication network 20′, using a bearer 91. The user device 30b communicates with an application associated with a latency sensitive service via the communication network 20′, using another bearer 92. To reduce end-to-end latency, the application dwells in a cloud edge 40B. The user device 30c communicates with an application dwelling in the Internet 40A using the bearer 91, as well as with an application associated with a latency sensitive service dwelling in the cloud edge 40B using the bearer 92.

The different bearers 91, 92 may be differentiated to provide different latency characteristics as exemplified above, using any suitable latency approach (e.g., any of the alternative approaches for latency control described herein).

As mentioned above, alternative approaches for latency control are provided by this disclosure. Some embodiments of the approaches for latency control address the problems associated with latency sensitive services (i.e., services with a sensitive relationship between latency requirements on the communication between the end points and the internal latency performance of the communication network).

A possible principle for alternative approaches for latency control is to improve the internal latency performance of the communication network (e.g., decreasing the maximum duration of transfer through the communication network, and/or decreasing the average duration of transfer through the communication network, and/or decreasing the variance of duration of transfer through the communication network, etc.). This may, for example, be achieved by avoiding unnecessary handovers and/or by controlling the setting of one or more network configuration parameter.

Another possible principle for alternative approaches for latency control is to dynamically vary the utilization of the communication network by the service in view of the latency requirements on the communication between the end points. For example, temporarily (when the internal latency performance of the communication network is poor) lowering a communication rate that the service applies in the communication network may temporarily improve the internal latency performance of the communication network (e.g., due to less HARQ retransmissions, etc.) at the cost of reduced throughput. The latter may be mitigated by temporary buffer build-up (compare e.g., with 31 and 42 of FIG. 1) within the boundaries set by latency requirements on the communication between the end points. This may, for example, be achieved by informing the application about current and/or future conditions of the communication network to allow the application to adjust its data rate.

The above possible principles may be used alone or in combination.

In some embodiments, the above possible principles are used exclusively for latency sensitive services, or only for communication end points associated with a latency sensitive service.

In the following, embodiments will be described where alternative approaches for latency control are provided. Some embodiments are particularly suitable for latency control in situations as that described in connection with FIG. 1. Furthermore, some embodiments apply the principle to improve the internal latency performance of the communication network.

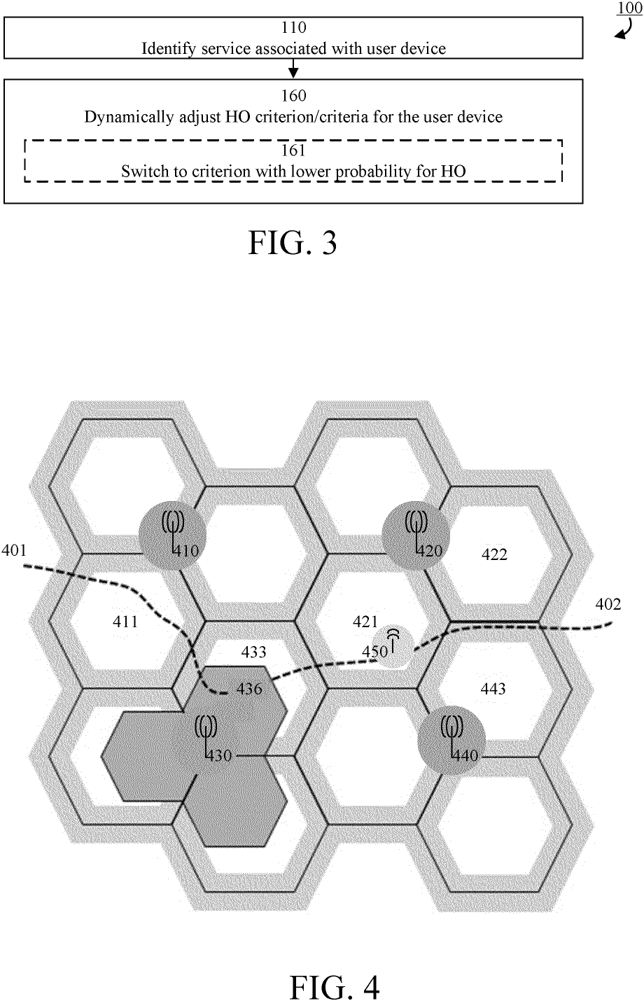

FIG. 3 illustrates an example method 100 according to some embodiments. The method is for latency control in a communication network (compare with communication networks 20 of FIG. 1 and 20′ of FIG. 2). The communication network is typically configured to serve a plurality of users (compare with 30a, 30b, 30c of FIG. 2).

Generally, latency control may refer to one or more of: mitigation of latency spikes, reduction/decrease of latency variance/variation associated with the communication network for the user device, reduction/decrease of average latency associated with the communication network for the user device, reduction/decrease of the probability for (i.e., number – e.g., per time unit – of) latency events associated with the communication network for the user device that exceed a latency threshold value, reduction/decrease of a maximum latency associated with the communication network for the user device, or any other suitable change in latency behavior.

A user device may, for example, comprise one of the communication end points 30, 40 of FIG. 1, one of the user devices 30a, 30b, 30c of FIG. 2, a user equipment (UE), a station (STA), or similar.

Also generally, latency control may be for mitigation of latency variations and/or for providing predictable latency and/or for providing reliable communication.

In typical embodiments, the latency control is performed under a throughput condition (e.g., that throughput should be kept at, or above, a minimum acceptable throughput).

In step 110, it is identified that a service is currently associated with a user device – the user device in turn being associated with (e.g., served by) the communication network – wherein the service has bounded deviation between a latency requirement of the service and an internal latency performance of the communication network.

That a service is associated with a user device may, for example, include that part of a service application (e.g., an application client) is running on the user device.

The service is the type of service elaborated on above – a service which relates to the communication network such that the latency requirements enforced by the service on the communication between the end points are not impossible, but not easy either, to accommodate by the internal latency performance of the communication network. This type of service is also referred to herein as latency sensitive services. This type of relationship between the service and the communication network is referred to herein by specifying that the deviation between a latency requirement of the service and an internal latency performance of the communication network is bounded.

One example that substantiates the bounded deviation between the latency requirement of the service and the internal latency performance of the communication network is that a ratio between a latency requirement parameter value of the service and an internal latency performance parameter value of the communication network falls within a bounding range. The bounding range may have any suitable value and/or may be dynamic or static.

Alternatively or additionally, one example that substantiates the bounded deviation between the latency requirement of the service and the internal latency performance of the communication network is that a latency requirement parameter value of the service and an internal latency performance parameter value of the communication network are in a same order of magnitude. For example, the same order of magnitude may be defined as not deviating more than a factor, e.g., 2, 5, or 10.

Alternatively or additionally, one example that substantiates the bounded deviation between the latency requirement of the service and the internal latency performance of the communication network is that a latency requirement parameter value of the service and an internal latency performance parameter value of the communication network are equal.

Alternatively or additionally, one example that substantiates the bounded deviation between the latency requirement of the service and the internal latency performance of the communication network is that a required end-to-end round-trip-time of the service falls within a time range specified relative an internal round-trip-time of the communication network.

The latency requirement parameter may, for example, refer to one or more of: latency variation, latency average, probability for latencies above a threshold value, maximum latency, or any other suitable latency metric. The internal latency performance parameter may, for example, be a corresponding parameter of the communication network (i.e., latency variation, latency average, probability for latencies above a threshold value, maximum latency, or any other suitable latency metric).

For 3GPP-based communication networks, the service might, for example, be a service which has a maximum allowable latency which is lower than that of mobile broadband (MBB) services and/or higher than that of ultra-reliable low latency communication (URLLC) services; or correspondingly for any other suitable latency requirement parameter.

The identification in step 110, that a service with bounded deviation between the latency requirement of the service and the internal latency performance of the communication network is currently associated with a user device, may be performed in any suitable way. Some illustrative examples include detecting that a service class identifier is indicative of the service, detecting that a bearer dedicated for low latency requirements is assigned for the service, detecting that single network slice selection assistance information (S-NSSAI) is indicative of the service, and/or determining that a traffic pattern of the service matches a latency sensitive traffic pattern.

In step 160, one or more handover criteria is dynamically adjusted for the user device associated with the service. The dynamic adjustment is for latency control as elaborated on above. For example, the dynamic adjustment of handover criteria may provide latency control by reducing the number of handovers for the user device, and/or by reducing the probability of handover for the user device.

The one or more handover criteria may, for example, comprise one or more handover related values (e.g., threshold values, parameter values, user configuration values, etc.).

In some embodiments, the adjustment is performed only for user devices associated with services with bounded deviation between the latency requirement of the service and the internal latency performance of the communication network. Thus, the adjustment may be applied in a differentiated fashion, whereby user devices associated with a service of this type are subject to the dynamic adjustment of handover criteria while other user devices are not. Hence, the other user devices may apply default handover criteria of the communication network.

In a typical example, step 160 comprises switching from a first handover criterion to a second handover criterion, wherein the first handover criterion corresponds to a first handover probability and the second handover criterion corresponds to a second handover probability which is lower than the first handover probability. This is illustrated by optional sub-step 161. The first handover criterion may be a default handover criterion of the communication network and the second handover criterion may be a handover criterion for latency sensitive services.

Alternatively or additionally, step 160 may comprise associating the user device with a handover inertia and/or reducing a probability of handover. Handover inertia may, for example, be defined as an increased delay in handover decisions and/or a reduced probability of handover.

Generally, the dynamic adjustment of step 160 may be applied equally to different (e.g., all) types of handover events of the user device, may be applied with different characteristics to different types of handover events of the user device, and/or may be applied to only some types of handover events of the user device.

Also generally, dynamically adjusting one or more handover criteria may comprise adjusting a handover measurement configuration of the user device and/or adjusting a handover decision criterion for the user device.

Adjusting a handover measurement configuration of the user device may comprise transmitting a configuration message to the user device, wherein the configuration message is indicative of the adjusted handover measurement configuration.

Adjusting handover measurement configuration may, for example, comprise reducing the amount of measurements and/or reducing reporting frequency. Thus, the user device may be configured to perform handover measurement more seldom (reduced measurement frequency) and/or to perform less handover measurements (e.g., excluding some cell(s) from measurements) and/or to transmit handover measurement reports more seldom. Performing handover measurement more seldom may, for example, be achieved by increasing a duration between periodically performed measurements and/or by adjusting condition(s) for triggering event-based measurements (e.g., performing measurements only when serving cell has very poor conditions; e.g., by lowering a signal quality threshold). Excluding some measurements may, for example, be achieved by conditioning measurements on new cells to be performed only when other neighboring cell(s) have very poor conditions.

Adjusting a handover decision criterion for the user device is typically a network internal process.

Adjusting a handover decision criterion for the user device may, for example, comprise applying more conservative conditions for triggering handover.

For example, adjusting a handover decision criterion for the user device may comprise adjusting one or more hysteresis values for handover decision between a serving cell and a target cell.

If a handover decision between a serving cell and a target cell is based on signal quality (e.g., if a handover criterion comprises that serving cell signal quality is less than the signal quality threshold value for serving cell and that target cell signal quality is greater than the signal quality threshold value for target cell), this may be implemented by decreasing a signal quality threshold value for the serving cell and/or increasing a signal quality threshold value for the target cell.

Corresponding examples apply for other measures than signal quality. Generally, a handover decision may be based on signal strength, received signal strength indicator (RSSI), signal quality, reference signal received power (RSRP), reference signal received quality (RSRQ), signal-to-interference ratio (SIR), bit rate, or any other suitable metric. Also generally, signal quality and/or other suitable measures are as measured by the user device on received signals.

Alternatively or additionally, adjusting a handover decision criterion for the user device may comprise adjusting a speed (or velocity) value which is used to determine handover triggering condition(s). For example, a speed threshold value may be applied below which a time between detection of handover conditions and triggering of the handover is longer than above the speed threshold value. Then, adjusting a handover decision criterion for the user device may comprise increasing the speed threshold value.

Alternatively or additionally, adjusting a handover decision criterion for the user device may comprise avoiding handovers that aim for keeping a user device always served by the best cell (e.g., with highest signal quality). Such approaches aim, instead, for keeping the user device served by the same cell as long as that cell is good enough (e.g., with a signal quality that is high enough to maintain service).

This may, for example, be implemented by adjusting a signal quality difference threshold value for signal quality differences between serving cell and target cell (e.g., if a handover criterion comprises that target cell signal quality minus serving cell signal quality is higher than the signal quality difference threshold value).

For example, if the default setting entails triggering a handover when the target cell is as strong as the serving cell (signal quality difference threshold value equal to zero), the adjustment may comprise increasing the signal quality difference threshold value (signal quality difference threshold value larger than zero).

Corresponding examples apply for other measures than signal quality. Generally, a handover decision may be based on signal strength, received signal strength indicator (RSSI), signal quality, reference signal received power (RSRP), reference signal received quality (RSRQ), signal-to-interference ratio (SIR), bit rate, or any other suitable metric.

Alternatively or additionally, adjusting a handover decision criterion for the user device may comprise avoiding handovers that are implemented for network optimization (e.g., load balancing between cells). Such approaches aim, instead, for keeping the user device served by the same cell as acceptable network optimization can be achieved (e.g., by handover of other user devices).

This may, for example, be implemented by enforcing other user devices to be primary targets for network optimization handovers. In some embodiments, the user device may be completely excluded from handover consideration in network optimization procedures (e.g., a load balancing procedure). In some embodiments, the user device may be excluded from being a primary target for handover consideration in network optimization procedures. The user device may, for example, be tagged with a value indicating it as secondary target for handover consideration in network optimization procedures, while user devices without an associated latency sensitive service are (implicitly or explicitly) indicated as primary targets for handover consideration in network optimization procedures.

In some embodiments, avoiding handovers that are implemented for network optimization is limited to lightly loaded scenarios. For example, if a cell is loaded above a load threshold value, the above exclusion(s) may be discarded.

In conclusion, FIG. 3 has demonstrated that latency variations of a communication network may be controlled by restricting the number of handovers (e.g., through user device configuration and/or adjusted decision criteria). By preventing unnecessary handovers (limiting handovers to situations when they are motivated for maintenance of the connection between user device and communication network), the number of communication interruptions can be reduced, which improves the quality of latency sensitive services.

In a typical communication network, handover may normally be triggered when a user device reaches a vicinity of the edge of the coverage area of the current (serving) cell. To maintain connection between the user device and the communication network, the user device typically needs to be handed over to another (target) cell which covers the area towards which the user device is moving. This type of handover scenario will be referred to as “Case 1” herein.

Other scenarios where handover may normally be triggered in a typical communication network relate to when the user device is at a location where several cells provide overlapping coverage. In such scenarios, a handover may be done even if a cell change is not necessary to maintain connection between the user device and the communication network. This type of handover scenario will be referred to as “Case 2” herein. One example is handovers triggered to keep the user device connected to the best cell. This type of handover scenario will be referred to as “Case 2a” herein. One example is handovers triggered to achieve load balancing between cells in the communication network. This type of handover scenario will be referred to as “Case 2b” herein.

Thus, some handovers are necessary to maintain connection between the user device and the communication network, while other handovers are not. The latter may aim for load balancing between cells in the network, or optimizing a non-latency parameter (e.g., signal strength) for the connection of the user device. The number of handover events can be reduced by avoiding unnecessary handovers, i.e., restricting handovers to those necessary to maintain an adequate connection between the user device and the communication network. Reducing the number of handovers, will typically reduce the number of communication interruptions and thereby improve the ability to support latency sensitive services.

FIG. 4 schematically illustrates some example principles according to some embodiments. In FIG. 4, the movement of a user device (a user equipment, UE) through a cellular communication network is represented by the dashed line from 401 to 402. The provision of the communication network is represented by four three-sector macro base stations 410, 420, 430, 440 and one small radio access node 450. The base station 430 uses two frequency bands providing almost overlapping coverage for its three sectors.

The UE performs measurements on the current (serving) and neighboring (prospective target) cells and reports results of the measurements to the communication network. The communication network uses the reported information (typically in combination with other network related information; e.g. cell load, UE mobility characteristics, etc.) to decide which cell the UE should be connected to. If it is decided that the UE is to change cell, a handover is initiated by the communication network.

Case 1 handover scenarios relate to situations where it may typically not be possible to completely avoid a handover. For example, a handover may be necessary to maintain connection since the UE is moving from the coverage area of one cell to that of another cell. This is illustrated in FIG. 4 by transitions from cell 411 to cell 433, from cell 433 to cell 421, and from cell 421 to cell 443.

However, case 1 handover scenarios also include situations where normal operation of the communication network causes unnecessary handovers. One cause of such unnecessary handovers is that the border between the coverage areas of the cells is not sharp (as indicated by the grey areas between the cells in FIG. 4). In practice, it is not uncommon to see a ping-pong effect, where several handovers are performed back and forth between two cells when the UE resides – stationary or in transition – in such areas (e.g., grey area between cells 422 and 443 in FIG. 4). The ping-pong effect may be caused by signal measurement values moving up/down in relation to decision thresholds that govern if and when a handover should be triggered or not. Some unnecessary case 1 handovers may be avoided for latency sensitive services by application of an adjusted (more conservative) setting for decision thresholds and/or decision hysteresis to reduce the handover probability. Alternatively or additionally, some unnecessary case 1 handovers may be avoided for latency sensitive services by configuring the measurements and/or reports of the UE to reduce the handover probability.

In the second type of handovers, i.e. the ones related to cell optimization (Case 2a) and load balancing (Case 2b), it is possible to avoid most handovers. UEs engaged in latency sensitive services can be treated differently from other UEs with more conservative rules for when to trigger a handover.

Cases 2 handover scenarios are illustrated in FIG. 4 by a first example when the UE is in an area covered by cells on two frequency bands 433, 436 and by a second example when the UE is in an area simultaneously covered by a macro cell 421 and the small radio access node 450. In these examples, adequate connection quality can be maintained from two different cells. In a typical communication network, the decision regarding which cell should be used for the UE may be based on criteria which aim towards optimizing link performance and/or balancing load between cells.

These case 2 handovers cause unnecessary communication interruptions, which may be beneficial to avoid for an individual UE that has an associated latency sensitive service. If the connection is good enough the UE should be kept in the current cell even if that is not the most optimal choice from link performance perspective (Case 2a). Alternatively or additionally, the UE should be kept in the current cell even if that is not the most optimal choice from network load balancing perspective (Case 2b); primarily targeting other UE:s for load optimization between cells. Some unnecessary case 2 handovers may be avoided for latency sensitive services by application of an adjusted (more conservative) setting for decision thresholds and/or decision hysteresis to reduce the handover probability. Alternatively or additionally, some unnecessary case 1 handovers may be avoided for latency sensitive services by configuring the measurements and/or reports of the UE to reduce the handover probability.

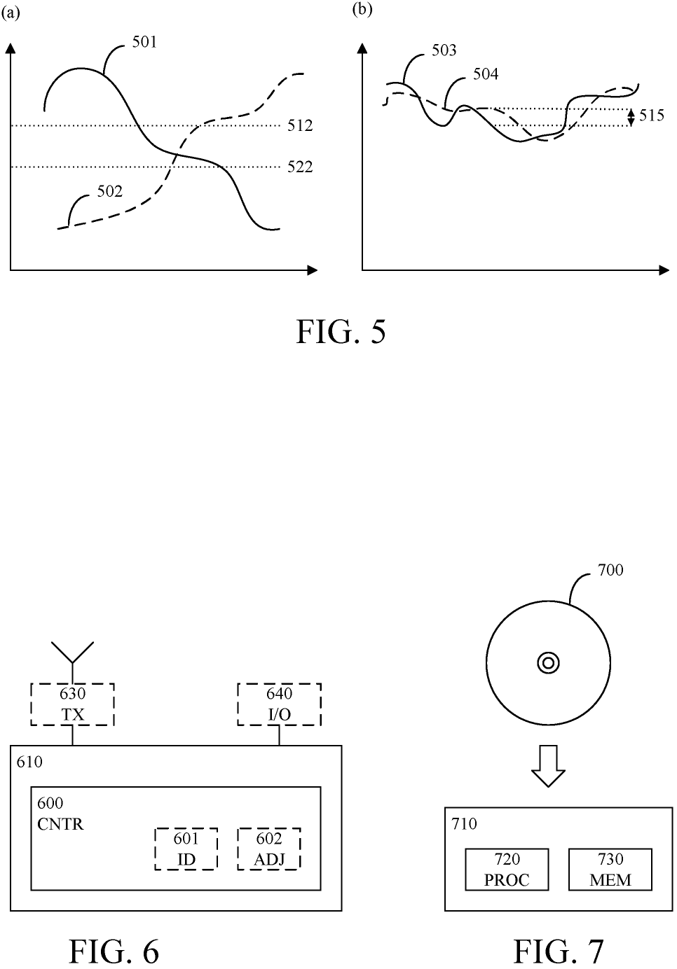

FIG. 5 schematically illustrates example principles according to some embodiments. The plots schematically show signal strength as a function of time. Corresponding examples apply for other measures than signal strength.

In part (a) of FIG. 5, the signal strength for the serving cell is represented by 501 and the signal strength for a prospective target cell is represented by 502. In some embodiments, a handover decision between serving cell and target cell is based on the signal strength (e.g., a handover criterion may comprise that serving cell signal strength is less than a signal strength threshold value 522 and/or that target cell signal strength is greater than a signal strength threshold value 512). Then a reduction of the number of handovers may be achieved by decreasing the signal strength threshold value 522 for the serving cell and/or increasing a signal strength threshold value 512 for the target cell.

In part (b) of FIG. 5, the signal strength for the serving cell is represented by 503 and the signal strength for a prospective target cell is represented by 504. In some embodiments, a handover decision between serving cell and target cell is based on the signal strength (e.g., a handover criterion may comprise that target cell signal strength minus serving cell signal strength is higher than the signal strength difference threshold value 515). Then a reduction of the number of handovers may be achieved by increasing the signal strength difference threshold value 515.

FIG. 6 schematically illustrates an example apparatus 610 for latency control in a communication network according to some embodiments. The apparatus 610 may, for example, be comprisable (e.g., comprised) in a network node (e.g., a radio access node such as a base station, or a central processing node). Alternatively or additionally, the apparatus 610 may be configured to cause execution of one or more of the method steps described herein (e.g., in connection with the method 100 of FIG. 3). The apparatus comprises a controller (CNTR; e.g., controlling circuitry or a control module) 600.

The controller 600 is configured to cause identification that a service is currently associated with a user device associated with the communication network, with bounded deviation between a latency requirement of the service and an internal latency performance of the communication network (compare with step 110 of FIG. 3).

To this end, the controller 600 may comprise or be otherwise associated with (e.g., connectable, or connected, to) an identifier (ID; e.g., identifying circuitry or an identification module) 601. The identifier may be configured to identify that a service is currently associated with a user device associated with the communication network, with bounded deviation between a latency requirement of the service and an internal latency performance of the communication network.

The controller 600 is also configured to cause dynamic adjustment of one or more handover criteria for the user device associated with the service (compare with step 160 of FIG. 3).

To this end, the controller 600 may comprise or be otherwise associated with (e.g., connectable, or connected, to) an adjuster (ADJ; e.g., adjusting circuitry or an adjustment module) 602. The adjuster may be configured to dynamically adjust one or more handover criteria for the user device associated with the service.

For example, the controlling circuitry may be configured to cause dynamic adjustment of the one or more handover criteria by causing switching from a first handover criterion to a second handover criterion, wherein the first handover criterion corresponds to a first handover probability and the second handover criterion corresponds to a second handover probability which is lower than the first handover probability.

Alternatively or additionally, the controlling circuitry may be configured to cause dynamic adjustment of the one or more handover criteria by causing association of the user device with a handover inertia and/or reduction of a probability of handover.

Alternatively or additionally, the controlling circuitry may be configured to cause dynamic adjustment of the one or more handover criteria by causing adjustment of a handover decision criterion for the user device.

Alternatively or additionally, the controlling circuitry may be configured to cause dynamic adjustment of the one or more handover criteria by causing adjustment of a handover measurement configuration of the user device.

To this end, the controller 600 may comprise or be otherwise associated with (e.g., connectable, or connected, to) a transmitter (TX; e.g., transmitting circuitry or a transmission module) 630 and/or an apparatus interface (I/O; e.g., interface circuitry or an interface module) 640. The transmitter may be configured to transmit a configuration message to the user device (e.g., when the apparatus is comprisable in a radio access node). The interface may be configured to transfer a configuration message to a radio access node for transmission to the user device (e.g., when the apparatus is comprisable in a central processing node).

In some embodiments, the controlling circuitry may be configured to cause dynamic adjustment of the one or more handover criteria only for user devices associated with services with bounded deviation between the latency requirement of the service and the internal latency performance of the communication network.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a network node.

Embodiments may appear within an electronic apparatus (such as a network node) comprising arrangements, circuitry, and/or logic according to any of the embodiments described herein. Alternatively or additionally, an electronic apparatus (such as a network node) may be configured to perform methods according to any of the embodiments described herein.

According to some embodiments, a computer program product comprises a tangible, or non-tangible, computer readable medium such as, for example a universal serial bus (USB) memory, a plug-in card, an embedded drive or a read only memory (ROM). FIG. 7 illustrates an example computer readable medium in the form of a compact disc (CD) ROM 700. The computer readable medium has stored thereon a computer program comprising program instructions. The computer program is loadable into a data processor (PROC; e.g., data processing circuitry or a data processing unit) 720, which may, for example, be comprised in a network node 710. When loaded into the data processor, the computer program may be stored in a memory (MEM) 730 associated with or comprised in the data processor. According to some embodiments, the computer program may, when loaded into and run by the data processor, cause execution of method steps according to, for example, any of the methods as illustrated in FIG. 3 or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for latency control in a communication network, the method comprising:
identifying that a service is currently associated with a user device associated with the communication network, wherein a deviation between a latency requirement of the service and an internal latency performance of the communication network is bounded; and
dynamically adjusting one or more handover criteria for the user device associated with the service.

2. The method of claim 1, wherein dynamically adjusting the one or more handover criteria is performed only for user devices associated with services with bounded deviation between the latency requirement of the service and the internal latency performance of the communication network.

3. The method of claim 1, wherein dynamically adjusting one or more handover criteria comprises switching from a first handover criterion to a second handover criterion, wherein the first handover criterion corresponds to a first handover probability and the second handover criterion corresponds to a second handover probability which is lower than the first handover probability.

4. The method of claim 1, wherein dynamically adjusting one or more handover criteria comprises associating the user device with a handover inertia and/or reducing a probability of handover.

5. The method of claim 1, wherein dynamically adjusting one or more handover criteria comprises one or more of:
adjusting a handover measurement configuration of the user device; and
adjusting a handover decision criterion for the user device.

6. The method of claim 1, wherein the dynamically adjusting one or more handover criteria comprises adjusting one or more handover related values.

7. The method of claim 1, wherein dynamically adjusting one or more handover criteria comprises one or more of:
decreasing a signal quality threshold value for serving cell; and
increasing a signal quality threshold value for target cell.

8. The method of claim 1, wherein dynamically adjusting one or more handover criteria comprises adjusting a signal quality difference threshold value for signal quality differences between serving cell and target cell.

9. The method of claim 1, wherein dynamically adjusting one or more handover criteria comprises excluding, in a load balancing procedure, the user device from consideration for handover.

10. The method of claim 1, wherein identifying that a service is currently associated with a user device, wherein the deviation between the latency requirement of the service and the internal latency performance of the communication network is bounded, comprises one or more of:
detecting that a service class identifier is indicative of the service;
detecting that a bearer dedicated for low latency requirements is assigned for the service; and
determining that a traffic pattern of the service matches a latency sensitive traffic pattern.

11. The method of claim 1, wherein the bounded deviation between the latency requirement of the service and the internal latency performance of the communication network comprises one or more of:
a ratio between a latency requirement parameter value of the service and an internal latency performance parameter value of the communication network falling within a bounding range;
a latency requirement parameter value of the service and an internal latency performance parameter value of the communication network being in a same order of magnitude;
a latency requirement parameter value of the service and an internal latency performance parameter value of the communication network being equal; and
a required end-to-end round-trip-time of the service falling within a time range specified relative an internal round-trip-time of the communication network.

12. The method of claim 1, wherein the service has a maximum allowable latency which is lower than that of mobile broadband, MBB, services and/or higher than that of ultra-reliable low latency communication, URLLC, services.

13. The method of claim 1, wherein the latency control comprises one or more of:
decrease of latency variance associated with the communication network for the user device;
decrease of a maximum latency associated with the communication network for the user device;
decrease of a number of latency events associated with the communication network for the user device, that exceed a latency threshold value; and
decrease of an average latency associated with the communication network for the user device.

14. A computer program product comprising a non-transitory computer readable medium, having thereon a computer program comprising program instructions, the computer program being loadable into a data processing unit and configured to cause execution of the method according to claim 1 when the computer program is run by the data processing unit.

15. An apparatus for latency control in a communication network, the apparatus comprising controlling circuitry configured to cause:
identification that a service is currently associated with a user device associated with the communication network, wherein a deviation between a latency requirement of the service and an internal latency performance of the communication network is bounded; and
dynamic adjustment of one or more handover criteria for the user device associated with the service.

16. The apparatus of claim 15, wherein the controlling circuitry is configured to cause dynamic adjustment of the one or more handover criteria only for user devices associated with services with bounded deviation between the latency requirement of the service and the internal latency performance of the communication network.

17. The apparatus of claim 15, wherein the controlling circuitry is configured to cause dynamic adjustment of the one or more handover criteria by causing switching from a first handover criterion to a second handover criterion, wherein the first handover criterion corresponds to a first handover probability and the second handover criterion corresponds to a second handover probability which is lower than the first handover probability.

18. The apparatus of claim 15, wherein the controlling circuitry is configured to cause dynamic adjustment of the one or more handover criteria by causing association of the user device with a handover inertia and/or reduction of a probability of handover.

19. The apparatus of claim 15, wherein the controlling circuitry is configured to cause dynamic adjustment of the one or more handover criteria by causing one or more of:
adjustment of a handover measurement configuration of the user device; and
adjustment of a handover decision criterion for the user device.

20. The apparatus of claim 15, wherein the controlling circuitry is configured to cause dynamic adjustment of the one or more handover criteria by causing adjustment of one or more handover related values.

21-28. (canceled)
